(19) United States
(12) Patent Application Publication
(10) Pub. No.: US 2021/0049650 A1
(43) Pub. Date: Feb. 18, 2021

(54) System and Method for Operating a Social Network for Automotive Quotes

(71) Applicant: Carprix, LLC, Ft. Lauderdale, FL (US)

(72) Inventor: Rodrigo Nunes Fuchter, Ft. Lauderdale, FL (US)

(21) Appl. No.: 16/982,868

(22) PCT Filed: Mar. 22, 2019
(86) PCT No.: PCT/US19/23629

§ 371 Date: Sep. 21, 2020

Related U.S. Application Data
(60) Provisional application No. 62/646,828, filed on Mar. 22, 2018.

(51) Int. Cl. G06Q 30/02; G06Q 50/00; G06Q 30/06; G06Q 10/10; G06F 8/61; H04W 4/14; H04W 4/06; H04L 12/58

(52) U.S. Cl. CPC G06Q 30/0278; G06Q 50/01; G06Q 30/0206; G06Q 30/0611; H04L 51/08; G06Q 10/10; G06F 8/61; H04W 4/14; H04W 4/06; G06Q 30/0625

(57) ABSTRACT

A system and method of implementing a social network for determining the value of vehicles that includes an application on a mobile device for selecting a group of known individuals, transmitting information about a particular vehicle to the group, receiving quotes reflecting the an estimation of the value of the particular vehicle, and displaying and storing the quotes.

This application claims priority to U.S. Provisional Appl. No. 62/646,828 filed Mar. 22, 2018, which is incorporated in its entirety by reference.

This application hereby incorporates by reference U.S. application Ser. No. 15/476,581. Mobile Crowd Sourced Vehicle Appraisal Application, in its entirety.

### BACKGROUND

Individuals purchasing and selling pre-owned cars and other pre-owned vehicles have a need to determine their likely resale value. Whether in the context of a private transaction, a dealer trade-in, or out of personal interest, both potential buyer and potential seller desire to have the most accurate value information in hand before considering, proposing, or entering into a transaction.

A number of solutions exist to address this need (including those discussed in the incorporated reference) and include books and websites that publish the value of recent transactions involving similar vehicles based on make, model and year, and then apply heuristics based on factors such as mileage, condition and optional features to adjust those values and predict a likely sale price either in a trade-in context or a private-sale context. The internal operation of such solutions are not necessarily well understood. Regardless, the output of such solutions suffer weaknesses, however, in that they are based on past transactions (albeit in a non-transparent way) and not on current market conditions. They also do not adequately take into account the location of the transaction, often combining transactions across an entire state or an entire zip code region, when the actual area of interest for a given transaction may be smaller or larger. A further weakness in such systems is that they cannot take into account special circumstances related to a particular vehicle such as aftermarket customizations, or the particularized condition of the vehicle (as opposed to a simple grading of condition on a coarse, fixed scale). In addition, specific information as to the parties involved in the transaction are not taken into account. For example, in a trade-in situation, the buyer may a dealer that specializes in a particular kind of vehicle and, thus, has a greater likelihood of being able to resell that vehicle than an individual or a dealer that does not specialize in that type of vehicle. In such situations, the buyer may also have a contact who has a particular customer who has previously requested such a vehicle. Similarly, a seller may be anxious for an immediate transaction, or may not be anxious at all and just interested in testing the market. Still further, such services have no way of knowing if the past transaction data they are using was based on transactions by sophisticated parties that came to an objectively reasonable deal or were based on circumstances such that the deal struck was not reflective of what two sophisticated, informed parties would have entered into. In any event, the historical information and heuristic adjustments of services like the Kelley Blue Book paper and online services, or the Black Book are unable to account for particularized conditions that can greatly impact the amount a buyer or seller might accept for a given vehicle and can be biased by transactions that are not truly at “market” for one reason or another.

Other solutions that claim to account for real-time conditions also have problems. Certain proposed solutions, such as those discussed in the incorporated reference, are based on a blind-bidding model where a group of strangers are asked to bid on a given vehicle in an online-auction-type setting. In such a setting bids may be biased by persons who are less sophisticated attempting to obtain an exceptional deal with low-ball offers. If the bids are not binding, it is also possible that users will not take the process seriously and will provide bids that are unrealistically high since there is no incentive to bid responsively. Such solutions also often suffer the problem that a specialized application or enrollment process is needed, which is inconvenient and, in some cases, requires a car dealer or other organization to invite users to participate, thereby limiting the audience. In certain cases a user may also be inconvenienced by having to establish a profile of the specific types of vehicles they are likely to purchase, creating a further barrier to use. Lastly, such solutions result in a many-buyer-to-one-seller model in which persons who may be in a position to facilitate a transaction, but who are not themselves interested in being a party to that transaction, have no incentive to participate.

In practice, enthusiasts and professionals have developed a manual, ad hoc work around for such problems using text messaging applications such as WhatsApp. An individual will simply text a description of the vehicle to a network of their personal acquaintances who they believe would be interested in a particular vehicle or who have expertise in the particular type of vehicle. Those persons will then use the same application to respond with a quote of the expect value and, sometimes, an offer. Alternatively, those persons may forward the description to persons in their personal network who they believe will be interested in the particular vehicle who will then respond back directly, as opposed to responding to the person who sent the first message. The result is a real-time evaluation of value based on quotes from specific individuals who the initial sender trusts to be experts or enthusiasts in a particular vehicle, and that covers a geographic region in which the initial sender is likely to do business, regardless of state or other borders. This results in a higher-quality, more realistic evaluation of value from a pre-qualified audience that is specific to a particular transaction and set of individuals and tends to result in a more realistic valuation than is possible with only historical market data or blind bids. It also does not require a preregistration process or the creation of any sort of a profile, which reduces the barriers to use and encourages easy, free communication.

The foregoing workaround has its own problems, however. It is ad hoc in nature and not typically applied in a consistent manner. Users are required to laboriously enter in details of the vehicle and its condition. In addition, messages in traditional text messaging applications are organized only by contact and not by vehicle or transaction. Since the persons involved may be friends, colleagues or acquaintances, communications about a particular vehicle are mixed with personal messages and/or messages on unrelated topics, creating organizational challenges. Further, the information is stored in such a way that it cannot be mined or analyzed conveniently, particularly across multiple users.

A need therefore exists for a system and method that allows individuals to solicit quotes about a particular vehicle from a social network of known individuals in a manner that does not require pre-installation of an application, can be used without pre-creation of an account or profile, simplifies data entry, allows for data analytics, and further allows for daisy-chain transmission of the requests to other known individuals and also to other users around.

### SUMMARY

A method of implementing a social network for vehicle quotes is disclosed. The method uses an application on a mobile device to type or obtain an image of a VIN or license plate of a vehicle, and then determine the make model and other information about the vehicle based on that input. Optionally pictures of the vehicle taken with the mobile device may be added to the vehicle information. A group of known individuals may then be selected from the contact list stored on the mobile device or the user can broadcast his car to other nearby users. The make, model, year and other information, together with any pictures, are then transmitted to the selected group of known individuals or to the other nearby users selected by geolocation radius, from about 10 to about 100 miles. The selected group of individuals may then transmit back quotes reflecting their estimation of the value of the vehicle. The quotes are displayed on the mobile device together with a portion of the information about the vehicle. In this way the opinions of a group of known individuals regarding the value of the vehicle are solicited and collected through the mobile device, the group of known individuals thereby forming a social network.

Also disclosed is a system for implementing a social network for soliciting quotes for vehicles from a social network of known individuals and from other nearby users. The system comprises a server connected to a plurality of mobile devices through a network. The mobile devices are specially programmed to obtain an image of a VIN or license plate of a vehicle and determine the make, model and other information about the vehicle based on that image. Optionally the mobile device may also store pictures of the vehicle taken with the mobile device. The mobile device is then further programmed to enable a user to select a group of individuals from the contact list stored on the mobile device and transmit the make, model, year and other information, and the pictures of the vehicle to the group of known individuals. The mobile device will then receive quotes reflecting the known individuals' estimation of the value of the vehicle and display the quotes together with a portion of the information about the vehicle to the user. The quotes sent from known users are shown with the name/contact information but the valuations and offers from unknown users that received the requisition thru the broadcast service can appear with undisclosed contact information but with disclosed value, then the user that first sent the request is able to pay inside the application in order to disclose contact information if they are interested in the received offer. The mobile device(s) will also transmit the quotes to a server, which is specially programmed to store quotes received from a plurality of such mobile devices. In this way the system creates a social network of known individuals qualified to provide value information for vehicles and the ability to store and perform data analytics on such quotes over time.

### BRIEF DESCRIPTION OF THE DRAWINGS

Other features in the invention will become apparent from the attached drawings, which illustrate certain preferred embodiments of the apparatus of this invention, wherein

FIG. 1 is a schematic view of an pricing cloud for vehicle information which may be created through the social network of the method and system of the present invention.

FIG. 2 is an embodiment of a system configured to implement a social network for vehicle quotes.

FIG. 3 is an embodiment of a data processing system used to implement a social network for vehicle quotes.

### DESCRIPTION OF EMBODIMENTS

While the following describes preferred embodiments of the invention, it is understood that this description is to be considered only as illustrative of the principles of the invention and is not to be limitative thereof, as numerous other variations, all within the scope of the invention, will occur to those of ordinary skill in the art.

As has been described above, there is a need for buyers and sellers to determine the value of automobiles and other vehicles in a manner that is more current and realistic than merely seeking bids from a group of strangers or querying past transactions involving similar vehicles. Embodiments of the present invention address this need by creating a social network of individuals (as opposed to dealers). The individuals may be enthusiasts or may be professionals who work at a dealership but leverage their own network of personal contacts to make sales, locate inventory, and assist in valuations. The result is a social network of persons the initial user trusts, as opposed to a cross section of unknown, unrelated individuals. By making that social network stronger and providing preferably free, easy-to-use tools that simplify and streamline information about vehicles, the user is able to obtain better, real-time quotes that more accurately reflect the value of a given vehicle to that user at that time.

Embodiments of the present invention utilize an application on a mobile device such as a smartphone. The initial user will download and install the application. The application will then scan the contacts on the mobile device, which are uniquely identified by a phone number, but which may also have a name or other personal identifying information stored with them. These contacts represent a known set of individuals with which the initial user has a pre-established relationship, or with whom the initial user has previously communicated. Based on that prior relationship or prior communication, the initial user will have knowledge of whether the contact is a person from whom the user would be interested in soliciting quotes on vehicles, if the person has a particular expertise in vehicles generally or a particular class of vehicles, and if the person is likely to be interested in providing quotes if so requested by the initial user.

In such an embodiment, the application may allow the user to easily collect information about a particular vehicle. One way of collecting such information would be to use the camera on the mobile device to capture an image of the vehicle identification number (VIN) or license number of the vehicle. The image may then be analyzed, either on the mobile device or on a server in communication with the mobile device, to determine the value of the VIN or license plate number. In the case of a VIN, the value may be decoded to determine such information as make, model, year, color, and option packages for the vehicle. Similarly, the value of the license plate number can be used to access databases that may provide similar information. Other databases may then be accessed to determine other information about the vehicle including market price reference, repair history, recall history, number of owners, location of initial purchase, etc. In this way, details about a given vehicle can be determined simply by taking a picture, without the need for laborious data entry.

The other information obtainable from a VIN or license plate number value can also be supplemented. The initial user may take photographs of the vehicle and/or enter notes or information about it. Such information may be free-form or may be collected in response to specific questions through text fields, radio buttons, drop downs, and similar user interface tools. All such information is associated with a particular vehicle.

Once the information is collected, the user may select known individuals from the list of contacts otherwise stored on the mobile device. Using the contacts on the device for the list of known individuals is preferred because it eliminates the need for a separate registration or data entry process to identify persons from which quotes may be solicited. Once the list is selected, the application will transmit messages to the mobile devices for those named individuals, asking them if they are interested in providing a quote for the vehicle. If the user opts to ask nearby users, the application can select other users around and send the quote request anonymously.

If a named individual has previously installed the application on their mobile device, an alert may be generated by that application. If the named individual has not installed the application, a standard text message or an email may be sent notifying the individual that they have received a request for a quote. In certain embodiments, the text message may include a link that, when activated, will cause the application to be downloaded and installed on the user's mobile device and the email may include car data, pictures, and the zip code from the requesting user. After installation, the request for quote will be displayed to the user in the newly-installed application. In such embodiments, there is no requirement that a contact previously install or be invited to install the application, or create any sort of an account or profile, prior to receiving a quote request.

The request for quote will then be displayed in the application, together with any additional information entered about the vehicle, including any pictures. The request will indicate the initial user, who will be a person known to the receiver based on some prior relationship. The individual receiving the request then has three options. He may ignore the request or respond that he does not wish to provide a quote. Alternatively, he may provide a quote or send a responsive message seeking additional information. Or, he may relay the request for a quote to any number of persons in the contact list of that individual stored on that individual's mobile device or even offer the received car to users around using the broadcast service. If the request for quote is relayed, the person receiving it will see it as a request for quote from that individual and need not know that the request originally began with someone else. The third individual then has the same options for responding to the request for quote as did the second individual. The result is a system that allows for an arbitrary number of relays from one individual to the next, with each individual being a known contact of the individual sending the request or being nearby to any individual that has received the quote request.

Responsive quotes and questions may come back from to a requester from any individual to whom the requester sent the request for quote. Responsive quotes and questions will be displayed in the application. In the case of quotes, the quote may be binding (an offer to enter into a transaction) or non-binding (an information-only response). Such quotes may be displayed both individually and in an aggregated form in the application, for example as an average. Communications about the quotes and/or the vehicle can then take place in a chat application that operates inside the application. In this way, communications are organized first by vehicle, and then by quote, making it easy for the user to see consolidated information in one place. Were a standard text messaging application to be used, as is possible in some embodiments, organization would be based only on contact, requiring the user to search multiple chat conversations to receive a full view of the communications regarding one vehicle.

Where requests for quotes are relayed from one user to the next, it is possible for intermediary users to serve as facilitators of a transaction, as opposed to buyers or sellers. In this way, a person who is not interested in a vehicle may forward the request to a third party who is interested. If that third party sends a suitable quote expressing a suitable level of interest, the requester may then send a different quote response to the original requester. The different quote response may include a mark-up or commission in addition to the quote originally provided. This provides an incentive to forward requests for quotes as the forwarder may have the opportunity to make a profit in the event an individual in his or her contact list is interested in the vehicle. Making the application free and easy to install, with no prior account creation or profile creation requirement facilitates such use in certain embodiments because it lowers the barriers to entry for using the system or method.

Quotes from known or nearby individuals who are thought to have an interest in a particular vehicle result in a more accurate determination of value. Accuracy is increased because the individuals are known to have expertise or a general level of interest. It is also increased by the fact that these known or nearby individuals are the persons with whom the requester is most likely to enter into a transaction. In certain embodiments, however, it may still be useful to display values obtained from historical transaction databases in conjunction with quotes. This provides a sanity-check, and helps avoid situations where an unrealistic quote or quotes are provided. The information gathered by the application about the vehicle should be sufficient to query a service such as Kelley Blue Book for such information for that purpose. Such information may be included in the request or quote or may be obtained separately from a server that a given mobile device may contact. That server may, in some embodiments, be operated by a third party. In other embodiments, the server may be operated by the provider of the application. In either event, having such information available for download by the application from a server avoids the necessity of storing a large volume of data locally on a mobile device. It will be understood, however, that the actual quotes from the social network of known or nearby individuals is far more likely to be reflective of the actual value of the vehicle to that person at that time, than would be the historically-based data from such a service.

While the primary audience for the previously described embodiment is individual users, as opposed to dealers, other embodiments may also provide advantages for dealers. In one embodiment, a dealer may establish an account on server available on a network such as the internet. That dealer may then use the account to connect people such as their own salespeople and staff that have installed the application on their mobile devices.

In such embodiments, the application may operate as previously described. However, as a result of it being connected from an invitation from a dealer, the application will transmit information regarding requests for quotes and quotes to the server, in addition to named individuals. The server may then store that information in a database and provide a user interface through which dealer users may review analytics based on quotes requested and received from multiple individuals. That user interface may be presented on a mobile device or through a web browser. A variety of reports can be generated from those analytics including reports indicating the types of vehicles that are generating the most activity, quotes within a particular range, and individuals who are most active. Such a service for a dealer may be a for-pay service, whereas embodiments of the application that has been described may be a free service.

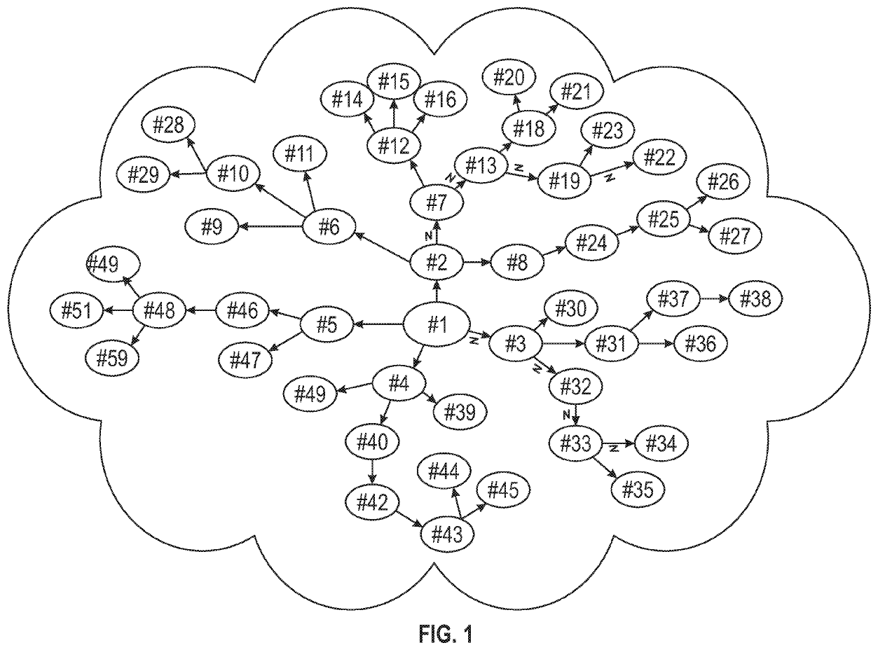

Referring now to FIG. 1, an illustration of the propagation of requests for quotes through a social network 100 of users is illustrated. As illustrated, user 1 uses the application to send a request for quote to users 2, 3, 4, and 5, each of whom represent known individuals existing in the contacts list of user 1 on user 1's mobile device and each of whom user 1 selected because user 1 believed they would have expertise or interest in the particular vehicle for which user 1 is attempting to obtain quotes. As illustrated, each of users 2, 3, 4, and 5 relay the request for quote to two or three users in their own respective contact lists, who they believe may have expertise or interest in the particular vehicle. For example, user 2 relays the request for quote to users 6, 7, and 8, each of whom are known to user 2, but not necessarily to user 1. Users 6, 7, and 8 need not know, or receive any information, suggestion that the request for quote did not first originate from user 2. All they need know is that user 2 is requesting a quote. The process then continues until the request for quote reaches a set of users that do not wish to relay it further.

Ultimately, some set of users may desire to provide a quote, either in the form of a binding offer or in the form of an opinion only (an information only quote). Other users may relay the request for quote without ever responding to the request. For example, as illustrated, user 5 merely passes the request for quote on to others, while user 47 chooses to ignore it, or to review it but not to pass it on. In either event, neither user 5 nor user 47 respond to the request.

As illustrated user 22 determines to respond with a quote (either as a binding offer or information only). That response is given only to user 19, the user from which user 22 received the request for quote, and to no others. User 19 now has a choice. User 19 may ignore the quote, or may respond back up the line with a quote of its own to user 13. In the case where user 22's quote is information only, user 19 may simply pass it back up the chain without modification. In the case where user 22's quote is a binding offer, user 19 may add a commission or finder's fee amount prior to passing the quote back to user 13. User 13 need have no information regarding whether the quote originated with user 19, or with another party further up the chain. User 13 may then make the same choice as user 19 had to make and may choose to relay the quote back to user 7 with or without modification. In this way, the method and system allow for multiple levels of finder's fees or commissions as an incentive to participate in the social network.

Ultimately, as illustrated, user 1 receives back two quotes. Each quote has come from a source that someone in the overall network has a personal relationship with and who is trusted by at least one person in the network. The quote is thus more reliable than one coming from strangers or based on historical information. It is also the case that the individuals shown in the figure represent those individuals to whom user 1 is most likely to sell the vehicle in any event, as those individuals are either in in user 1's social network directly (as is the case with users 2, 3, 4 and 5), or indirectly, as with the other users illustrated. In the case where sales are more likely to occur based on personal relationships than walk-ins or blind advertising, the illustrated model provides particularly accurate quotes. It is further the case that, due to the instant messaging aspect of the embodiment, the quotes may be received in real time or near real time, allowing user 1 to make an informed decision more quickly.

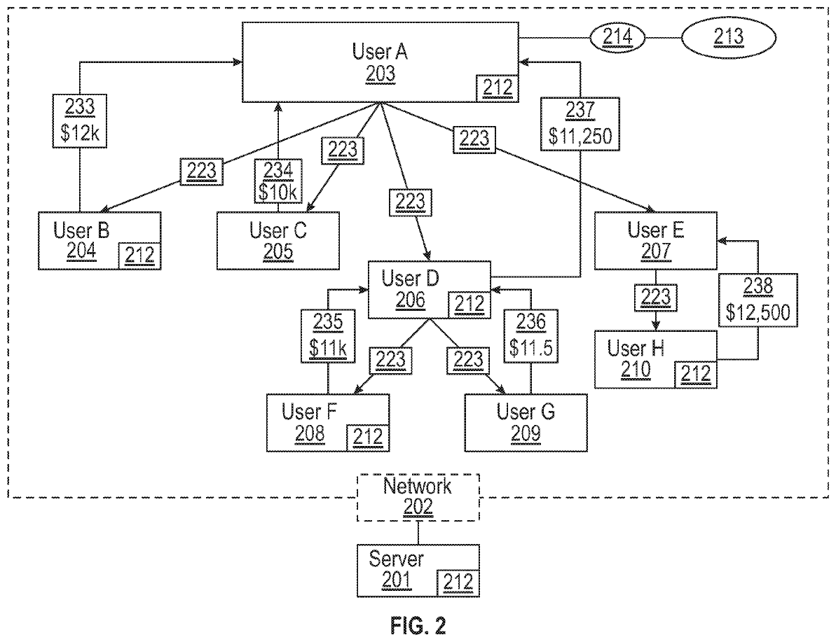

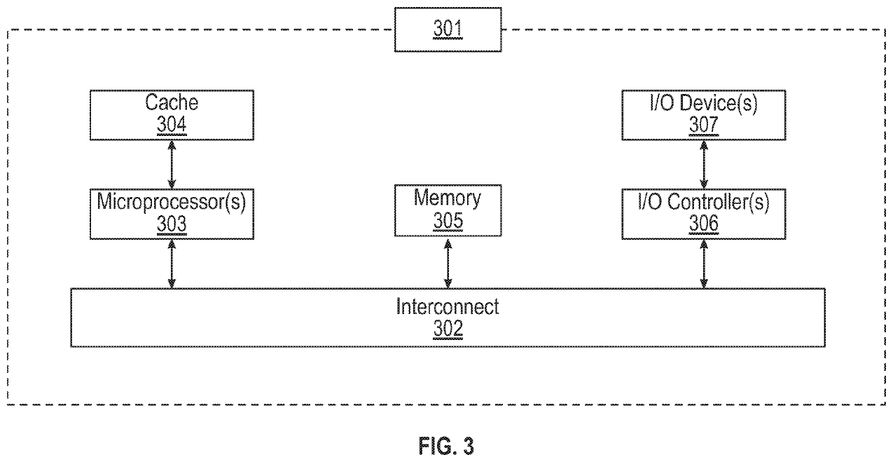

FIG. 2 represents a system configured to provide services according to an embodiment of the invention. In one embodiment, the services are implemented at least in part in a server device 201, which can be implemented using one or more data processing systems as illustrated in FIG. 3. A plurality of user devices are coupled to the server device 201 via a network 202, which includes a local area network, a wireless communications network, a wide area network, and/or the Internet. A user device (e.g. 203 (User A), 204 (User B), 205 (User C), 206 (User D), 207 (User E). 208 (User F), 209 (User G), 210 (User H)) can be one of various points connected to a network, such as a personal computer, a tablet, a cellular phone, a smart phone, and/or a mobile phone.

In an embodiment, a first user collects information 214 about a particular vehicle 213. The first user selects individuals from a list of contacts stored on a user device 203 and accessed through an application 212 that is installed and operates on the user device 203. In one embodiment of the invention, the user can view the status of contacts in the application—for those contacts that also have installed the application on their user device—and view whether certain contacts are currently available for bids, not available for bids, uncertain about bidding, or other particular statuses that can be provided through the application to be viewed by other users that have the user in their contact lists. After selecting certain users from the first user's list of contacts in the application 212, the first user sends a message (223) containing the information 213 about a particular vehicle 211 to the selected users—on their user devices.

In FIG. 2, the selected users' devices are 204-207. The user devices may receive the message on the application 212 if that is installed on their devices. If the user does not have the application installed on their device, the message 223 is received on their user device as a text message, instant message, or other similar message type known in the art. The application 212 installed on the first user's (here User A) device determines whether the selected users' device has the application 212 installed on the selected user's device, and sends the appropriate message type as described above.

As shown in FIG. 2, the message 223 is transmitted to the application 212 installed on user devices 204 and 206, and optionally the application 212 generates alerts on user devices 204 and 206. The message 223 is transmitted as a text message to user devices 205 and 207. The message 223 prompts the user of user devices 204-208 for a quote on the particular vehicle 211. In one embodiment of the invention, the text message transmitted to user devices also includes a link to download the application 212—which after downloading by the user, allows for the user to respond using messages generated by the application 212 rather than text messages. The message 223 will also display the information 213 about the particular vehicle along with the prompt for a quote.

Users may choose not to respond to the message 223. In one embodiment, users may also respond to message 223 with a binding or non-binding quote, and/or a request for new information. FIG. 2 shows User B responding to message 223 with a binding quote of $10.000 by message 233 from the application 212 installed on user device 204. FIG. 2 also shows User C responding to message 223 with a non-binding quote of $12,000 by a text message 234. In certain embodiments, various metadata related to the messages are stored by the server 201 in storage device 203. For instance, the binding quote $10,000 233 of User B could be stored along with the user who made the quote (User B), the response time for the quote, and that the quote request was not relayed to another user device. If a user does not respond to a quote request, then the failure of the user to respond can be saved. If a binding quote is accepted, that acceptance can also be stored as metadata or otherwise.

In certain embodiments, users may choose to relay the message that includes the particular vehicle and vehicle information. In FIG. 2, User D relays the message 223 to User F using the application 212. User F receives the relayed message 223 via the application installed on 208. User F then responds to User D's relayed message with a binding quote of $11000 by message 235 from the application 212. User D also relays the message to User G using the application 212—the application 212 converts the message to a text message 236 that is received by User G. User G responds to the relayed message 223 with a binding quote of $11,500 as a text message 236. After receiving messages 223, 235, and 236, User D can relay the quotes of 235 as 236 as submitted by Users F and G to User A without markup. If User D chooses this option, then User A could be made aware that the quote originated with Users F and G and could respond to these Users based on metadata saved on the server from messages sent and received by the application 212. User D may also accept either of the quotes in messages 235 and 236 and markup the quote some amount and send the quote, as marked up, to User A without indicating the original quote originated with User F or User G. In FIG. 2. User D takes User F's quote in message 235 and marks up the quote by $250 and sends the marked up quote of $11.250 to User A via a message 237 generated in the application 212.

In FIG. 2, User A also transmits message 223 via the application 212 to User E—the application converts the message 223 to a text message which is received by User E. User E then relays the message 223 to User H via text message. User H has the application 212 installed on device 210. The application 212 recognizes the type of request and information contained in message 223 and converts it to a message in application 212. In some embodiments, the application 212 allows for a user to optionally choose whether certain text messages should be converted to messages in the application 212 based on the request and information in the message. In some embodiments, the text message is not converted by the application 212 to a message in the application. In FIG. 2, User H responds to message 223 with a non-binding quote of $12,500 in a message 238 generated in the application 212. The application 212 converts the message 238 to a text message which is received by User E. In FIG. 2. User E chooses not to relay message 238 back to User A. In some embodiments, the metadata associated with message 238 would be directed to the server 201 by the application 212 and stored. In certain embodiments, users would optionally have the ability to prevent any data related to their messages from being stored by the application 212. In some embodiments, the application would anonymize the metadata stored from the message metadata stored on the server, such that any further use of the metadata, following anonymization could not identify the user associated with the data.

After receiving messages 233,234, and 237 shown in FIG. 2, User A has received the following quote information: Two binding quotes for $10000 and $11.250 and one non-binding quote for $12.000. In some embodiments, the application 212 will allow User A to compare these quotes with commercial appraisal sources like Kelly Blue Book. In certain embodiments, the application 212 will also allow User A to store the response times and metadata related to the responses from the users who respond—and do not respond—to the request (here 223).

In an embodiment of the invention, a user has access to the aggregated metadata stored by an application, for example, the application described in FIG. 2 which collects the metadata of users in a social network that prompts for quotes on certain vehicles. In a further embodiment, a user has total access to all of the application users and can optionally use the application to manage vehicle sales and compare, valuate, and analyze the vehicles using the metadata stored by the application, and optionally from other sources, including commercial sources.

The embodiment described in FIG. 2, as well as other embodiments and features of the invention, allow for an efficient bidding/quoting process and related data storage, including through a defined system and method of using an application as part of the quoting and bidding process. The application also provides a benefit of accessible and analyzable data from the quoting process, both historically and in real time, and importantly, it allows for data from text message participants who interact with users that have the application installed. It also provides the efficiency of converting application messages to text and text messages to application messages as described in the embodiments above. This conversion process allows for a more robust social network process by not requiring all users to download a mobile application. Without even an application download, users can still participate with the quoting and bidding process, and interact with other users with the application in a seamless, efficient manner. Similarly, the application users can interact with text message participants in a seamless manner without having to use text messaging and application messaging, thus, the invention provides an efficiency to both sides of the experience.

In one embodiment, at least some of the components of the system disclosed herein can be implemented as a computer system, such as a data processing system illustrated in FIG. 3, with more or fewer components. Some of the components may share hardware or be combined on a computer system. In one embodiment, a network of computers can be used to implement one or more of the components.

In one embodiment, data discussed in the present disclosure can be stored in storage devices of one or more computers accessible to the components discussed herein. The storage devices can be implemented as a data processing system illustrated in FIG. 3, with more or fewer components.

FIG. 3 illustrates a data processing system according to one embodiment. While FIG. 3 illustrates various parts of a computer system, it is not intended to represent any particular architecture or manner of interconnecting the parts. One embodiment may use other systems that have fewer or more components than those shown in FIG. 3.

In FIG. 3, the data processing system 301 includes an interconnect 302 (e.g., bus and system core logic), which interconnects a microprocessor(s) 303 and memory 305. The microprocessor 303 is coupled to cache memory 304 in the embodiment of FIG. 3.

In one embodiment, the interconnect 302 connects the microprocessor(s) 303 and the memory 305 together and also connects them to input/output (I/O) device(s) 307 via 110 controller(s) 306. I/O devices 307 may include a display device and/or peripheral devices. In one embodiment, when the data processing system is a server system, some of the I/O devices 307 are optional.

In one embodiment, the inter-connect 302 includes one or more buses connected to one another through various bridges, controllers and/or adapters.

In one embodiment, the memory 305 includes one or more of ROM (Read Only Memory), volatile RAM (Random Access Memory), and non-volatile memory. Such as hard drive, flash memory, etc.

The non-volatile memory can be a local device coupled directly to the rest of the components in the data processing system. A non-volatile memory that is remote from the system, such as a network storage device coupled to the data processing system through a network interface.

In this description, some functions and operations are described as being performed by or caused by software code to simplify description. However, such expressions are also used to specify that the functions result from execution of the code/instructions by a processor, such as a microprocessor.

While one embodiment can be implemented in fully functioning computers, computer systems, mobile devices, and the like, various embodiments are capable of being distributed as a computing product in a variety of forms and are capable of being applied regardless of the particular type of machine or computer readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions that can include one or more instructions set at various times in various memory and storage devices in a computer, smartphone or the like, and that, when read and executed by one or more processors, cause the performance of operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or networks. Different portions of the data and instructions can be obtained from different centralized servers and/or networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

In general, a machine readable medium includes any mechanism that provides (i.e., stores and/or transmits) information in a form accessible by a machine (e.g., a computer, mobile devices, network device, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

An further embodiment of the invention is a method of implementing a social network for determining the value of vehicles comprising using an application on a mobile device to obtain an image of a VIN or license plate of a vehicle; determine the make model and other information about the vehicle based on said image of a VIN or license plate; optionally adding pictures of the vehicle taken with the mobile device; select a group of known individuals from the contact list stored on said mobile device; transmitting said make, model, year and other information and said pictures of the vehicle to said group of known individuals; receiving from said group of known individuals quotes reflecting the known individuals' estimation of the value of the vehicle; display said quotes together with a portion of said information about said vehicle wherein the opinions of the group of known individuals regarding the value of the vehicle are solicited and collected through said mobile device. In certain embodiments, the make, model, year and other information are transmitted through an application installed on a recipient's mobile device. Also, in certain embodiments, a text message is transmitted to said recipient, said text message comprising a link through which the recipient may install the application on the recipient's mobile device. In a further embodiment involves performing the steps of obtaining a likely value based on past sales data for like vehicles from a web server and displaying an alert if any said quote varies from said likely value by more than a predetermined value or a predetermined percentage. A further embodiment includes providing a website through which a dealer may invite specific individuals to install said application on their mobile devices, after which said website will collect all said quotes received by said individuals and provide to said dealer a searching and analytics interface through which said dealer can track and report on quotes received based on one or more of individual, vehicle make, vehicle year, vehicle type, vehicle value, time of year, and number of quotes received. In certain embodiments, said website predicts a likely value of a vehicle based on past quotes received by said individuals and said likely value excludes any quote that varies by a predetermined amount or a predetermined percentage from a predicted value determined from past.

Another embodiment of the invention is a system for implementing a social network for determining the value of vehicles comprising a server connected to a plurality of mobile devices through a network wherein said mobile devices are specially programmed to obtain an image of a VIN or license plate of a vehicle; determine the make model and other information about the vehicle based on said image of a VIN or license plate; optionally store pictures of the vehicle taken with the mobile device; select a group of known individuals from the contact list stored on said mobile device; transmit said make, model, year and other information and said pictures of the vehicle to said group of known individuals; receive from said group of known individuals quotes reflecting the known individuals' estimation of the value of the vehicle; display said quotes together with a portion of said information about said vehicle; and transmit said quotes to a server; said server being specially programmed to store said quotes received from a plurality of said mobile devices. In certain embodiments, the server is further specially programmed to present a user interface for querying said stored quotes.

Other embodiments of the above described invention will also be apparent to those skilled in the art based on the present description, all of which are to be considered alternative embodiments of the present invention. The present invention is not intended to be limited to only those embodiments expressly described herein.

1. A method of determining the value of vehicles comprising providing an application on a mobile device for
selecting a group of known individuals from the contact list stored on said mobile device;
transmitting information about a particular vehicle to said group of known individuals
wherein the application determines which of the selected known individuals have installed the application on their mobile device and transmits said information in a message that is displayed in the application for the known individuals with application installed on their mobile device and transmits said information in a text message for the known individuals without the application installed on their mobile device;
receiving from said group of known individuals quotes reflecting the an estimation of the value of the particular vehicle
wherein the application displays said quotes together with a portion of said information about said vehicle and stores the metadata related to said quotes.

2. The method of claim 1 further comprising providing an application on a mobile device for transmitting a text message to a known individual, said text message comprising a link through which the recipient may install the application on the recipient's mobile device.

3. The method of claim 1 further comprising providing an application on a mobile device for obtaining a likely value based on past sales data for like vehicles from a web server and displaying an alert if any said quote varies from said likely value by more than a predetermined value or a predetermined percentage.

4. The method of claim 1 further comprising providing a website through which a dealer may invite specific individuals to install said application on their mobile devices, after which said website will collect all said quotes received by said individuals and related metadata and provide to said dealer a searching and analytics interface through which said dealer can track and report on quotes received based on one or more of individual, vehicle make, vehicle year, vehicle type, vehicle value, time of year, and number of quotes received.

5. The method of claim 5 wherein said website predicts a likely value of a vehicle based on past quotes and related metadata received by said individuals.

6. The method of claim 1 further comprising providing an application that stores a quote and related metadata from a text message received from an individual who was not one of the selected known individuals.

7. The method of claim 1 further comprising providing an application that receives a text message from an individual who was not one of the selected known individuals and displays the content of said text message in the application of one of the selected known individuals.

8. A system for determining the value of vehicles comprising a server connected to a plurality of mobile devices through a network wherein said mobile devices are specially programmed with an application for
selecting a group of known individuals from the contact list stored on said mobile device;
transmitting information about a particular vehicle to said group of known individuals
wherein the application determines which of the selected known individuals have installed the application on their mobile device and transmits said information in a message that is displayed in the application for the known individuals with application installed on their mobile device and transmits said information in a text message for the known individuals without the application installed on their mobile device;
receiving from said group of known individuals quotes reflecting the an estimation of the value of the particular vehicle
wherein the application displays said quotes together with a portion of said information about said vehicle and stores the metadata related to said quotes.

9. The system of 8 wherein said server is further specially programmed to present a user interface for querying said stored quotes.

10. The system of claim 8 further comprising said application on a mobile device transmitting a text message to a known individual, said text message comprising a link through which the recipient may install the application on the recipient's mobile device.

11. The system of claim 8 further comprising said application on a mobile device obtaining a likely value based on past sales data for like vehicles from a web server and displaying an alert if any said quote varies from said likely value by more than a predetermined value or a predetermined percentage.

12. The system of claim 8 further comprising a website through which a dealer may invite specific individuals to install said application on their mobile devices, after which said website will collect all said quotes received by said individuals and related metadata and provide to said dealer a searching and analytics interface through which said dealer can track and report on quotes received based on one or more of individual, vehicle make, vehicle year, vehicle type, vehicle value, time of year, and number of quotes received.

13. The system of claim 12 wherein said website predicts a likely value of a vehicle based on past quotes and related metadata received by said individuals.

14. A method of implementing a social network for determining the value of vehicles comprising using an application on a mobile device to
select a group of known individuals from the contact list stored on said mobile
